(19) United States
(12) Patent Application Publication
(10) Pub. No.: US 2006/0188610 A1
(43) Pub. Date: Aug. 24, 2006

(54) Modular apparatus with timer and method for nutrition system utilizing portions determined by the eater's weight

(76) Inventor: Willian Christopher Powell, Tempe, AZ (US)

Correspondence Address: ETHERTON LAW GROUP, LLC, 5555 E. VAN BUREN STREET, SUITE 100, PHOENIX, AZ, 85008, US

(21) Appl. No.: 11/404,400

(22) Filed: Apr. 14, 2006

Related U.S. Application Data
(63) Continuation-in-part of application No. 11/303,337, filed on Dec. 16, 2005.
(60) Provisional application No. 60/646,116, filed on Jan. 21, 2005.

(51) Int. Cl. A22C 17/10

(52) U.S. Cl. 426/87

(57) ABSTRACT

A nutrition system utilizing multiple food containers that have graduated indicia to indicate quantity of food therein, wherein the indicia are determined by an eater's weight. Preferably the food containers are color-coded to indicate the type of macronutrient inside. The containers fit inside an insulated carrier that is large enough to hold at least four meals' worth of containers. Containers of macronutrients are combined to form meals. Preferably the carrier is collapsible so that it can be made smaller as the meals are eaten throughout the day. The carrier includes a timer and, optionally, a food scale. In the preferred embodiment, the meals are combined in such a way to cause weight loss. During the first day, a person ingests four high-carbohydrate meals and one low-carbohydrate meal. During a second day, a person ingests four low-carbohydrate meals, each with a tablespoon of a fat, and one high-carbohydrate meal.

### CROSS-REFERENCE TO RELATED APPLICATIONS

This application claims the benefit of co-pending U.S. patent application Ser. No. 11/303,337 filed Dec. 16, 2005, which claims the benefit of U.S. Provisional Application No. 60/646,116 filed Jan. 21, 2005.

### FIELD OF INVENTION

This invention relates to a diet system. More particularly, this invention relates to a system of ingesting certain types and portions of food provided in modular containers that indicate the size of the portions by the eater's weight.

### BACKGROUND

People worldwide have learned that it is important to eat, or refrain from eating, certain foods to attain or maintain good health. Which certain foods a particular individual can ingest depends on the person and his or her health condition. For example, people with diabetes may be advised to eat low sugar foods; those who want to avoid colon cancer may be advised to eat high fiber foods; those who are overweight may be advised to eat low calorie foods. Moreover, Americans have been on a weight-loss craze for the past several decades: the Pritikin diet; the South Beach diet or other low-carbohydrate diet; the Zone diet; or the low-protein diet, are just a few examples.

Popular diet and weight-loss programs offer continually improving theories, protocols, and guidance to people who wish to maintain good health or who wish to lose weight. These diets and programs typically design meals for consumption based on unique proportions and volumes of macronutrients, including proteins, carbohydrates, and fats. For example, the Zone Diet, developed by Dr. Barry Sears, makes an effort to balance insulin and glycogen, resulting in weight loss initially and then, eventually, homeostasis. The Zone teaches that the caloric content of each meal should consist of 40% carbohydrate, 30% protein, and 30% fat. In another example, U.S. Pat. No. 6,040,531, assigned to Weight Watchers, discloses a process for controlling body weight in which selection of food servings is based on a calculated point value and range of allotted daily points, which is adjusted for weight change. Determining which foods fit within a desired food plan can be difficult because it often involves reading the fine print on a food label for ingredients and quantity, and making calculations for a given serving size vs. package size. It would be desirable to have a diet that eliminates calculation.

Some diets, particularly those that aim to maintain blood sugar level or metabolic rate, are implemented by eating certain quantities of certain foods at prescribed times. Almost every medically sound diet and nutrition regimen for weight loss, performance, strength gain, muscle gain, recovery, rehabilitation, disease management, or overall wellness is based upon consumption of meals every 2 to 4 hours—leading to the consumption of 5 to 6 meals each day. Somewhat surprisingly, remembering to eat at these smaller intervals can be difficult for a number of reasons. American culture has ingrained eating only three meals a day, spaced apart at long and uneven intervals. Work or play may intervene, taking longer than the desired interval or occurring where it is inconvenient to find and eat proper food. And, until the body becomes accustomed to eating more frequently, it may not signal that it is hungry at these shorter intervals. It would be desirable to have a nutrition system that makes it easier to remember when to eat.

Despite these advancements, many individuals following these diet protocols often experience difficulty following the proper timing, macronutrient portion sizes, and number of meals prescribed. These difficulties may be exacerbated by the complexity of diet program protocols, the availability or accessibility of prescribed macronutrients at the consumer's immediate location. For example, police officers, as a generalization, are concerned about maintaining their fitness, including good nutrition. However, they are often in their cars all shift and are unable to cook each meal, resorting to vending machines or frequent trips to restaurants, both of which are expensive and neither of which typically provide proper macronutrients. It would be desirable to have a nutrition system that greatly increases the convenience of eating properly.

Therefore, an object of this invention is to provide a method and apparatus that eliminates the need to calculate proper macronutrient portions in a desired diet. Another object is to minimize the difficulty of following a diet's protocols. Another object is to maximize the availability and accessibility of macronutrients prescribed by a diet. Another object is to make it more convenient to eat according to a desired diet at a desired time.

### SUMMARY OF THE INVENTION

This invention is a nutrition system utilizing multiple food containers that have graduated indicia to indicate quantity of food therein, wherein the indicia are determined by an eater's weight. Preferably the food containers are color-coded to indicate the type of macronutrient inside. The containers fit inside an insulated carrier that is large enough to hold at least four meals' worth of food containers. The carrier includes a timer and, optionally, a food scale. It may also hold a fat container. Containers of macronutrients are combined to form meals. Preferably the carrier is collapsible so that it can be made smaller as the meals are eaten throughout the day.

In the preferred embodiment, the meals are combined in such a way to cause weight loss. During the first day, a person ingests four high-carbohydrate meals and one low-carbohydrate meal, each at an interval of 24 hours from the last. During a second day, a person ingests four low-carbohydrate meals, each with a tablespoon of a fat, and one high-carbohydrate meal, each at an interval of 2-4 hours from the last.

### BRIEF DESCRIPTION OF THE DRAWINGS

FIG. 1 is a front perspective view of the carrier with the top open;

FIG. 2 is a rear perspective view of the carrier with one side open.

FIG. 3 is a cross section of the carrier along line 3-3 of FIG. 2.

FIG. 4 is a cross section of the carrier in a partially collapsed configuration.

FIG. 5 is a perspective view of a container with two compartments.

### DETAILED DESCRIPTION OF THE INVENTION

While “diet” has attained a general connotation of a weight-loss program, “diet” as used herein has the broader meaning of a “food plan.” “Food” includes all things ingestible, including all foods and beverages. As used throughout, the term “meal” means one or more foods eaten at about the same time.

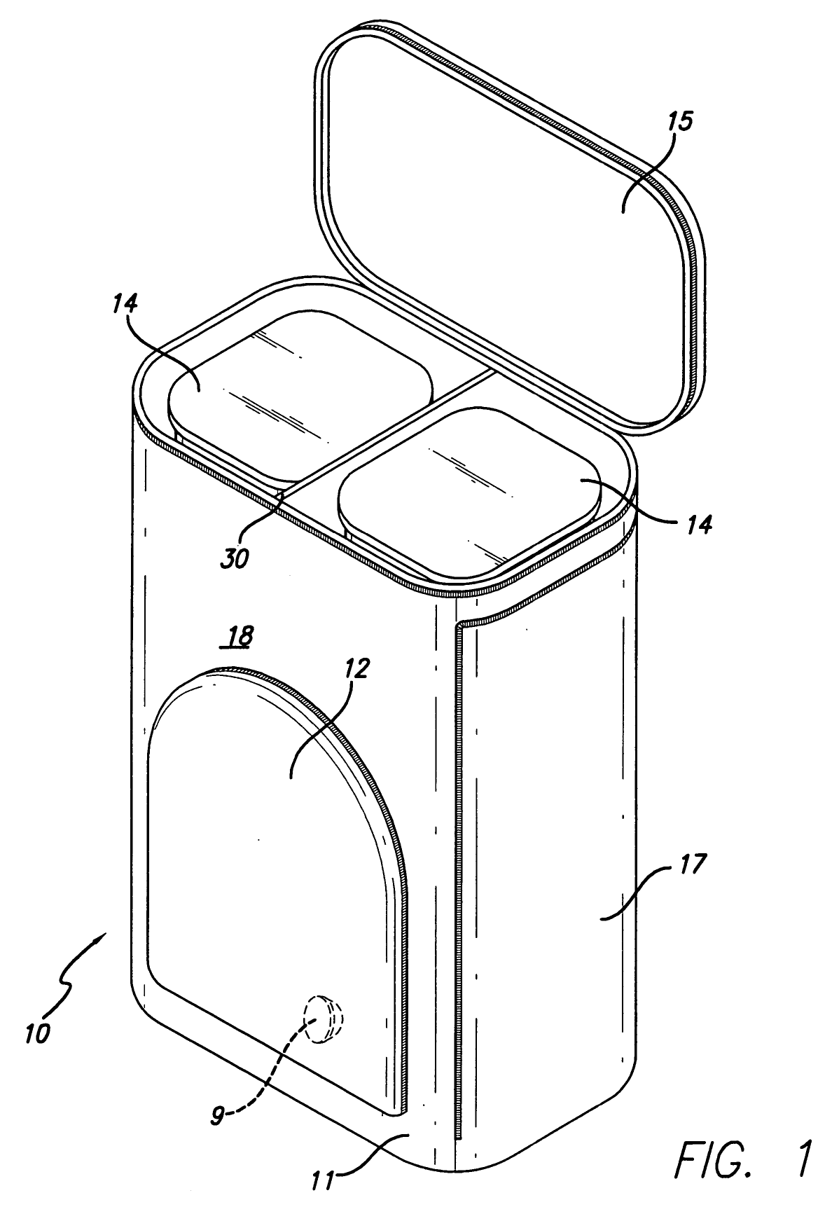

Referring to the drawings and particularly to FIGS. 1 to 4, there is illustrated an apparatus for carrying food, generally designated 10. The apparatus comprises a carrier 11 and one or more meal containers 14 that fit within the carrier 11. The carrier may also hold a fat container 9. Meal containers 14 and fat containers 9 are referred to collectively herein as “containers.” The carrier has a top 15, a first side 16 and a second side 17, a front 18, a back 19, and a bottom 20. The figures show a carrier that allows the containers to be stacked vertically. Alternatively, the containers can be stacked side-by-side so that the carrier 11 resembles a duffle bag. Preferably the carrier is sized to hold at least four meals, the meals eaten away from home. (Most people tend to eat breakfast (a fifth meal) at home and do not need to carry it with them.) This system makes following a diet more likely because it is more convenient. The eater can fill the containers necessary for all their daily meals in the morning (or evening prior) and transport them in one container, eliminating the need to prepare meals five times a day or carrying multiple lunch pails.

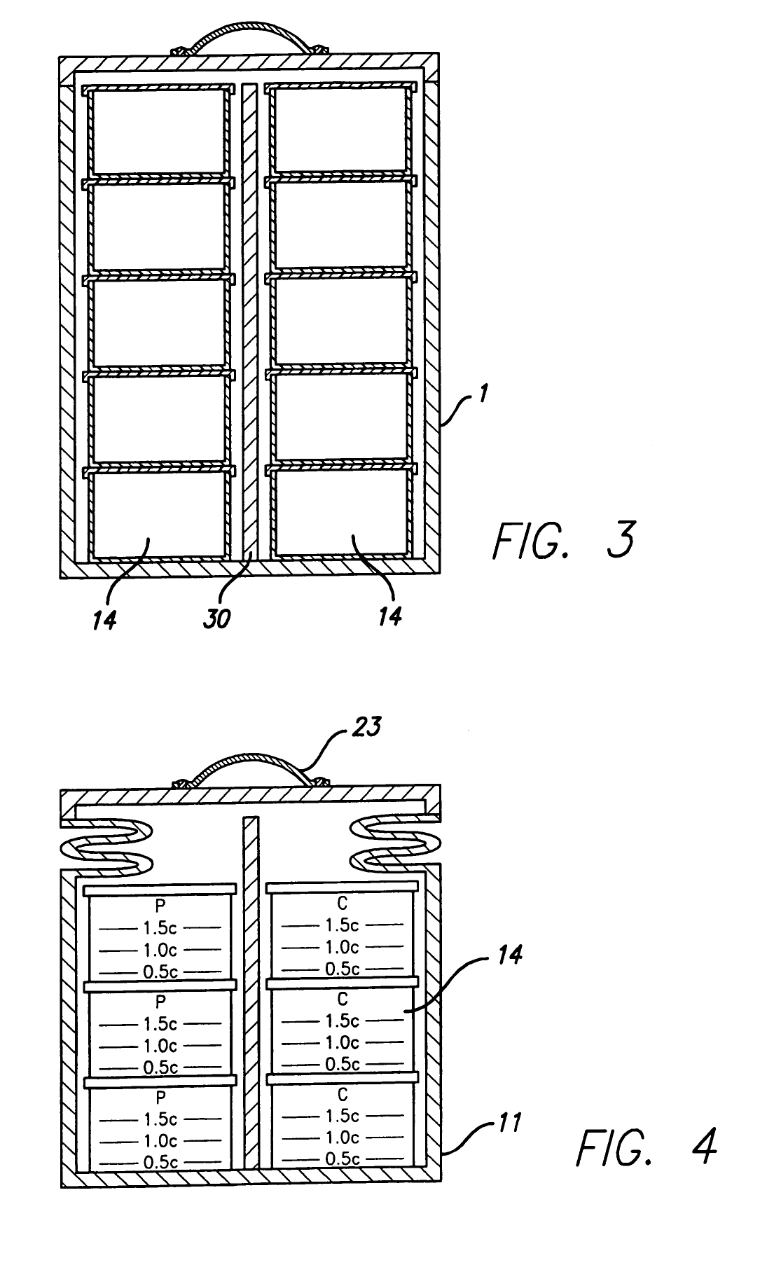

Preferably the carrier 11 is insulated and may include one or more removable thermo packs 30 to keep the food warm or cold, such as an ice pack, gel pack, or heat pack, as known in the art. Preferably one thermo pack 30 fits vertically between two stacks of containers, which are described in more detail below. The inventor has determined that the containers are more evenly cooled by placing thermo pack vertically between the containers, as shown in FIG. 3, but a thermo pack may also fit in or be attached to the top, sides, front, rear, or bottom. The carrier may be configured to allow for extra space for the one or more thermo packs. The carrier may be further configured to provide compartments or sections that hold and maintain their contents at different temperatures, such as a warm section for soups and a cool section for perishables.

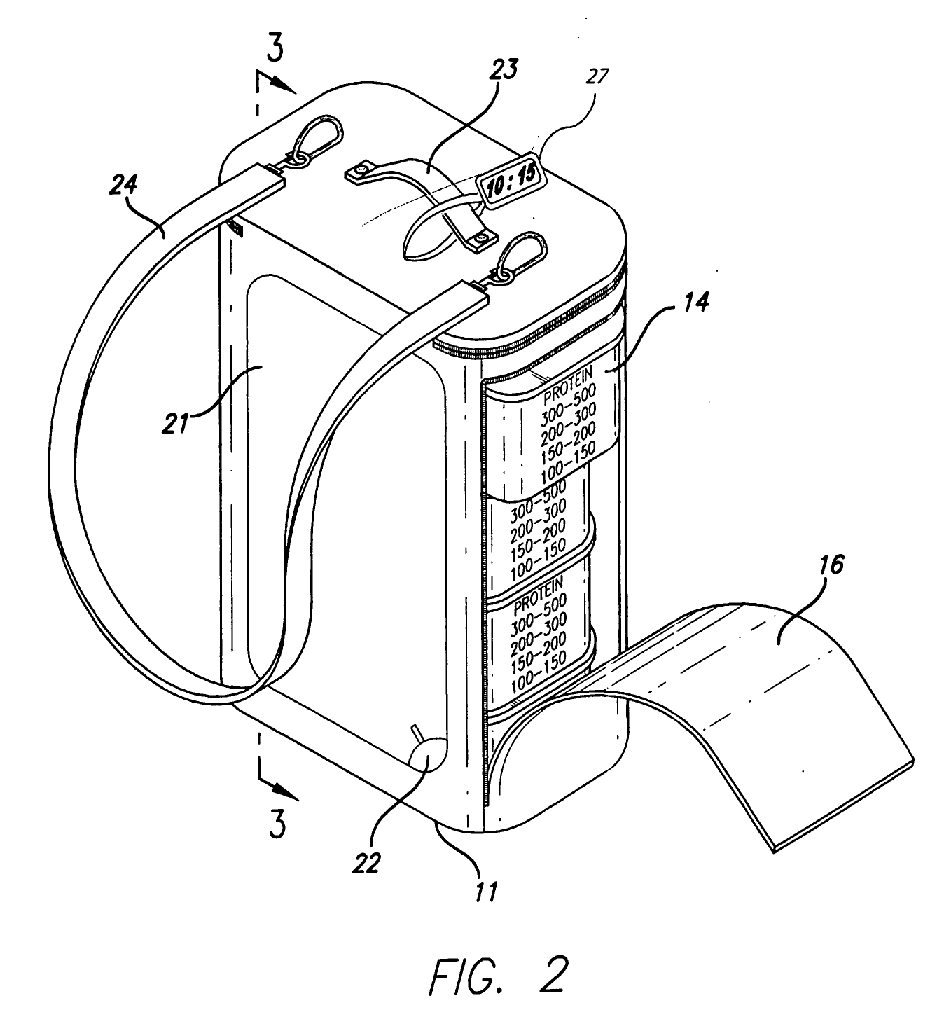

The carrier 11 may be accessed through the top, front, rear, bottom or sides. In the preferred embodiment, the user can open the top and each side to access the containers inside. Preferably the containers pull out from the side. See FIGS. 1 and 2. Alternatively, the top or each side may have a window-like portion that can be opened, providing similar access. Preferably the openings are attached with zippers, Velcro®, snaps, or other attachment mechanism that permits varying degrees of entry into the carrier. For example, FIG. 2 shows the first side 16 unzipped about ⅘ths of the way to the bottom, thereby remaining sealed over the bottom container to keep it cold.

The carrier 11 may also have one or more pouch or pocket 12 to carry items such as eating utensils, vitamins, napkins, spices, straws, etc., or even containers for fat, as explained in more detail below. Optionally, the carrier may be sized to leave space near the top 15 for carrying such items. Particularly, the top may be configured to provide space for a food scale. Preferably at least one pocket is closeable and attached to the front 18, as shown in FIG. 1, but the pocket 12 may be attached elsewhere on the carrier 11, as well. The pocket may be configured to carry specific items such as a water bottle or cell phone. The carrier 11 may also be equipped with hooks or other devices for attaching items such as a water bottle or car keys. For portability, the carrier is equipped with one or more handles or straps. FIG. 2 shows a handle 23 and a strap 24 attached to the top 15.

The carrier includes a timer that issues a reminder for when the next meal should be eaten. In the preferred embodiment, the timer is digital and is programmed to sound an alert every 2.5 hours to notify the eater it is time to eat a meal. FIG. 2 shows a digital timer 27 attached to the handle 23. The timer may be digital or analog, permanently or removably attached to the carrier or, alternatively, it may be integral with the carrier. Any type of reminder can be used. For example the reminder may be visible, such as a flashing light; audible such as a beep, ring tone, or motivational message; or tactile, such as a vibration.

Preferably the carrier 11 has a bladder 21 for convenient storage of a fluid, such as water, and the convenient consumption of the fluid through a mouthpiece 22 configured for access when in use, yet closed to prevent spilling when not in use, as is known in the art. An exemplary design of this sort is provided by the Camelbak® brand of products.

The carrier 11 may be hard-shell or soft-shell. Preferably the carrier is soft-shell and configured so that it can progressively collapse, accordion-style, as containers are removed. See FIG. 4. This helps prevent the containers from shifting during transport. Further, a smaller carrier saves space and is easier to carry and store. Alternatively, the carrier may be made in modular portions that can be separated and stored as the meals are eaten. Each modular portion is preferably attached to the next with a zipper or Velcro®. This may be particularly useful for use with disposable containers, as described in more detail below.

If collapsibility is not of primary concern, the sides may have rods or other structural support to keep the carrier upright. The carrier may gain further stability by choice of a suitable closing mechanism for the sides, such as Velcro® or a heavy zipper. Preferably the bottom is relatively sturdy to provide stability for keeping the carrier upright, and may further utilize peg-like feet or legs to keep the bottom from touching the surface the carrier rests on. Finally, the device may be equipped with wheels for easy transport.

Preferably the carrier 11 has the size and shape to mate with the containers so that they are held substantially in place and do not shift appreciably when the carrier is moved. This helps prevent the food from spilling and protect the containers from damage. The inside of the carrier 11 may be undivided or may be partitioned by shelves, sewn-in cloth separators, or in the case of a hard-shelled container, molded plastic pieces that are integral with the container.

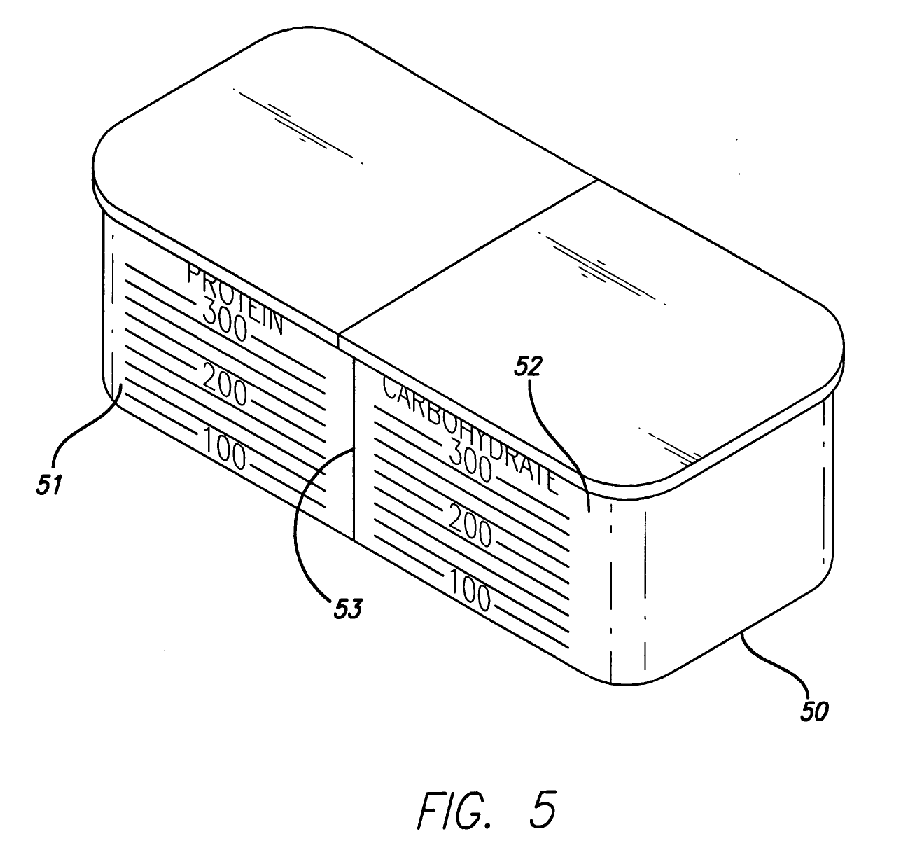

Each meal container 14 holds food of varying portion sizes. In the preferred embodiment, each meal container 14 has indicia to indicate quantity of food therein, wherein the quantity indicia are determined by an eater's weight. The indicia are graduated, with a larger portion for heavier people. For example, FIG. 2 shows graduated portions sizes for people of 100-150 lbs., 150-200 lbs, 200-300 lbs., and 300-500 lbs. The line separating the low and high end of the weight range serves as the indicator, so the user would fill the meal container up to the line for his or her then-current weight. In another embodiment, the containers are graduated in smaller increments so that an eater can fill the containers to a volume more closely-tailored to his or her weight. See FIG. 5.

For weight loss under the present system, the eater puts less food in each meal container as his or her weight decreases, as explained in more detail below. The indicia are preferably visual marks on the outside, as shown in FIGS. 2 and 5, but may also be tangible projections or depressions indicating the gradations. Preferably the meal containers are substantially rectangular to have clearly demarcated sides for easier identification of the diet. Rectangular meal containers fit more efficiently into a mated, rectangular carrier.

In the preferred embodiment, the body-weight gradations have the following volume equivalents:

Protein

| body weight (lbs) | ounces |
|---|---|
| 300 and up | 10 |
| 200 | 8 |
| 150 | 6 |
| 100 | 4 |

Carbohydrates

| body weight (lbs) | cups |
|---|---|
| 300 and up | 2.5 |
| 200 | 2 |
| 150 | 1.5 |
| 100 | 1 |

In addition to meal containers 14, the carrier 11 may also carry or one more fat containers 9. A fat container can have substantially the same shape as a meal container 14 to more easily stack in the carrier 11, or it may have a different shape to more easily be carried in or on the pocket 12, top 15, sides 16 and 17, front 18, back 19, or bottom 20. FIG. 1 shows a fat container 9 carried in the pocket 12.

Each container may indicate the quality of food by volume. This is particularly useful for those who are eating to maintain health, such as diabetics or those who are physically fit, but are not necessarily concerned with their weight. Each container may also indicate the portion size specified by a given diet. For example, the container may have indicia for the Zone diet, or the Body for Life diet. Each container may have multiple indicia. For example a square container may have the indicia determined by an eater's weight on one side, the Zone diet on another side, the Body For Life diet on a third side, and quantity in volume or weight on the fourth side.

While the preferred embodiment uses containers with graduated indicia, for increased convenience the size of each container may be designed to accommodate the proper portion for any individual. In this case, the containers are simply filled close to the brim, thereby reducing the time spent and avoiding possible confusion associated with measuring and self-administering the proper amount of food as prescribed by the individual's diet. A combination of containers with indicia and those without may be used, for example meal containers with indicia and fat containers without indicia.

The containers preferably contain one type of food, but can be configured to contain more than one type of food, for example a container with multiple compartments. See FIG. 5 showing a container 50 with two compartments created by a divider 53. One compartment 51 is for protein food and a second compartment 52 is for carbohydrate food. Alternatively, the container can hold macronutrients in combination with other macronutrients for a particular meal exclusively, such as a soup made of protein, carbohydrate, and vegetable. Preferably the containers are made of a washable and re-usable material, such as plastic or metal, and have lids. However, the containers may also be made of paper or wax-coated paper. This material may be particularly useful for one-use disposable containers or containers of prepared food sold through retail outlets, fast food restaurants, or vending machines.

The diet system is implemented by eating certain quantities of certain foods at prescribed times. Almost every medically sound diet and nutrition regimen for weight loss, performance, strength gain, muscle gain, recovery, rehabilitation, disease management, or overall wellness is based upon consumption of meals every 2 to 4 hours—leading to the consumption of 5 to 6 meals each day. Each meal is comprised of the combinations of specific macronutrients, i.e. carbohydrates, proteins, and fats. The containers of the present invention can be combined in any fashion to satisfy the meal requirements of any diet and nutrition regimen. In addition, the portion sizes and measurements of the specific nutrition regimen can be marked and measured on the sides of the containers to ensure proper calorie and macronutrient intake. The container system can accommodate various nutrition regimens including, but not limited to: weight loss, performance, strength gains, muscle gain, recovery, rehabilitation, disease management, or overall wellness.

In the preferred embodiment, the nutrition system is for weight loss, including those that are diagnosed as “morbidly obese,” which is usually defined as a person that is 50-100% or 100 pounds above his or her ideal body weight. The system requires ingesting at least five meals a day. All meals contain protein; some meals also contain carbohydrates, vegetables or fat. (While vegetables may contain carbohydrates, as used herein “vegetable” means a very low carbohydrate food, as distinguished form a “carbohydrate” that means a higher carbohydrate food, as known in the art.) One meal, referred to herein as a “high-carbohydrate meal” is made of a protein and carbohydrate. The high-carbohydrate meal is made by determining a protein portion size based on an eater's current weight and measuring that protein portion size of a protein food into a first container; and determining a carbohydrate portion size based on an eater's current weight and measuring that carbohydrate portion size of a protein food into a second container. Another meal, referred to herein as a “low-carbohydrate meal” is made of a protein and vegetable. The low-carbohydrate meal is made by determining a protein portion size based on an eater's current weight and measuring that protein portion size of a protein food into a first container; and adding an unlimited portion size of vegetables into a second container or containers. Vegetables are unlimited for all weights.

Various factors determine the combination of high-carbohydrate and low-carbohydrate meals eaten, including the eater's goal, for example weight loss or blood glucose level; physiology, for example high or low metabolism; and psychology, for example dislike of certain food groups. The preferred embodiment is for weight loss and is predicated on an eater willing to eat foods that are the best physiologically. In this preferred embodiment, during a first day an eater ingests four carbohydrate meals and one low-carbohydrate meal. These are higher-carbohydrate days, which help boost metabolism. During a second day, the eater ingests four low-carbohydrate meals, each with a tablespoon of a fat, and one high-carbohydrate meal. These are lower-carbohydrate days, which help burn fat. The eater then returns to the combination of meals eaten on the first day, namely ingesting four carbohydrate meals and one low-carbohydrate meal. This is again followed by the meals from the second day, namely four low-carbohydrate meals, each with a tablespoon of a fat, and one high-carbohydrate meal. The first day and second day sets of meals are alternated until the dieter loses the desired amount of weight.

In a second embodiment, which may appeal to those that are willing to trade-off rigorous physiological application of the foods to gain a measure of psychological comfort, the eater eats only high-carbohydrate meals on a first day and eats only low-carbohydrate meals on a second day. The eater alternates days of eating only high-carbohydrate meals with days of eating only low-carbohydrate meals. Other embodiments may combine a different number of high-carbohydrate meals with a different number of low-carbohydrate meals per day, as well as other permutations of the sequence of high-carbohydrate days and low-carbohydrate days, adapting the diet to the eater's needs, physiology, and goals.

Preferably the dieter exercises while on this food plan. Exercise designed to strain the cardio system is done on the lower-carbohydrate days, and strength training is done on the higher-carbohydrate days.

If the eater's weight loss plateaus, the eater eats high-high-carbohydrate meals for seven consecutive days, and then returns to alternating higher-carbohydrate day with lower-carbohydrate days the following week.

While there has been illustrated and described what is at present considered to be a preferred embodiment of the present invention, it will be understood by those skilled in the art that various changes and modifications may be made, and equivalents may be substituted for elements thereof without departing from the true scope of the invention. Therefore, it is intended that this invention not be limited to the particular embodiment disclosed as the best mode contemplated for carrying out the invention, but that the invention will include all embodiments falling within the scope of the appended claims.

I claim:

1. A nutrition system comprising:
a) one or more containers having quantity indicia to indicate quantity of food therein;
b) a carrier to which the containers are mated; and
c) a timer.

2. The system of claim 1 wherein the quantity indicia are determined by an eater's weight.

3. The system of claim 1 wherein the quantity indicia are graduated.

4. The system of claim 1 further comprising type indicia on each container to indicate type of food therein.

5. The system of claim 4 wherein the type indicia are colors.

6. The system of claim 4 wherein the type is one of protein, carbohydrate, vegetable, or fat.

7. The system of claim 1 further comprising a food scale.

8. The system of claim 1 wherein the carrier is insulated.

9. The system of claim 1 wherein the carrier is collapsible.

10. The system of claim 1 wherein the carrier further comprises a fluid bladder.

11. A nutrition system comprising:
a) one or more containers each further comprising:
i. quantity indicia to indicate quantity of food therein;
ii. type indicia on each container to indicate type of food therein, wherein the type is one of protein, carbohydrate, vegetable or fat;
b) a carrier to which the containers are mated; and
c) a timer.

12. The system of claim 11 wherein the container further comprises a top, a first side, a second side, a front, a back, and a bottom, and the top and each side open to provide access the containers inside.

13. A nutrition system for weight loss comprising:
a) making a high-carbohydrate meal by:
i. determining a protein portion size based on an eater's current weight and measuring that protein portion size of a protein food into a first meal container; and
ii. determining a carbohydrate portion size based on an eater's current weight and measuring that carbohydrate portion size of a protein food into a second meal container;
b) making a low-carbohydrate meal by:
i. determining a protein portion size based on an eater's current weight and measuring that protein portion size of a protein food into a third meal container; and
ii. measuring an unlimited portion size of a vegetable into a fourth meal container;
c) during a first day, ingesting four high-carbohydrate meals and one low-carbohydrate meal, each at a desired time interval indicated by a timer;
d) during a second day, ingesting four low-carbohydrate meals, each with a tablespoon of a fat, and one high-carbohydrate meal, each at a desired time interval indicated by a timer.

14. The system of claim 13 wherein each container has quantity indicia to indicate quantity of food therein, wherein the quantity indicia are determined by an eater's weight.

15. The system of claim 13 wherein the quantity indicia are graduated.

16. The system of claim 13 further comprising type indicia on each meal container to indicate type of food therein.

17. The system of claim 16 wherein the type indicia are colors.

18. The system of claim 13, further comprising a carrier to which the meal containers are mated.

19. The system of claim 13 wherein the carrier further comprises a fluid bladder.

20. The system of claim 13 wherein the carrier further comprises a food scale.
